(19) United States
(12) Patent Application Publication
(10) Pub. No.: US 2014/0005983 A1
(43) Pub. Date: Jan. 2, 2014

(54) MICROSCALE MODELING OF POROUS MEDIA FLOW

(71) Applicants: Thomas Alva BAER, Township, OH (US); Mel ALLENDE-BLANCO, Loveland, OH (US); Jianjun FENG, West Chester, OH (US); Douglas Gregory STEVENS, Cincinnati, OH (US); Matthew Joseph MACURA, Loveland, OH (US)

(72) Inventors: Thomas Alva BAER, Township, OH (US); Mel ALLENDE-BLANCO, Loveland, OH (US); Jianjun FENG, West Chester, OH (US); Douglas Gregory STEVENS, Cincinnati, OH (US); Matthew Joseph MACURA, Loveland, OH (US)

(21) Appl. No.: 13/537,495

(22) Filed: Jun. 29, 2012

(51) Int. Cl. G06F 17/50

(52) U.S. Cl. CPC G06F 17/5018
USPC 703/1

(57) ABSTRACT

Methods of using computer based models for simulating a porous media.

### FIELD

In general, embodiments of the present disclosure relate to computer based models for absorbent articles. In particular, embodiments of the present disclosure relate to methods of using computer based FEA and CFD models for simulating the properties of porous media by microscale modeling of the fiber networks.

### BACKGROUND

Absorbent articles include diapers and incontinence garments as well as feminine pads and liners. Absorbent articles can receive, contain, and absorb bodily exudates. It can be difficult to predict the physical behavior of bodily fluids as they are received into and absorbed by an absorbent article. As a result, it can be difficult to predict whether or not an absorbent article of a particular design can adequately contain bodily exudates.

### SUMMARY

A method of simulating a porous media is disclosed. The method includes analyzing a product sample to generate a three dimensional grayscale image. The method also includes importing the grey scale image into a binary mapping program and constructing an isosurface of solid structures from the binary mapping. The method further includes applying a meshing tool to the exported isosurface to construct hexdominant mesh on open space surrounding the product geometry. A free surface model is then constructed using embedded interface method (e.g. volume-of-fluid) on the meshed geometry. A monolithic data set is reconstructed. The method also includes employing a visualization tool to view and extract pertinent solution information from the monolithic data set.

### BRIEF DESCRIPTION OF THE DRAWINGS

FIG. 1 is a chart illustrating a method of using computer based models for simulating the physical behavior of a bodily fluid with an absorbent article.

FIG. 2 is a chart illustrating a computer system.

FIG. 3 is a illustration of the progression from micro CT tomography imagery to a 3D representation of a fibrous substrate sample broken up over FIGS. 3A-3D.

FIG. 3A contains a photo of the micro CT scan grid.

FIG. 3B contains a depiction of the micro CT scan grid.

FIG. 3C contains a depiction of a surface rendering of the product geometry based on the micro ct scan grid.

FIG. 3D contains a depiction of a hexdominant mesh constructed to fill the void space between the film and fibrous structures.

FIG. 4 is a progression in time representation of fluid migration through the micro CT derived geometry broken up over FIGS. 4A-4D.

FIG. 4A contains fibers, air between fibers or void space, and fluid.

FIG. 4B is a representation of 4a after a fixed amount of time FIG. 4b contains fibers, air between fibers or void space, and fluid.

FIG. 4C is a representation of 4a after a fixed amount of time. FIG. 4c contains fibers, air between fibers or void space, and fluid.

FIG. 4D is a representation of 4a after a fixed amount of time. FIG. 4c contains fibers, air between fibers or void space, and fluid.

### DETAILED DESCRIPTION

As used herein “absorbent article” refers to a device or implement that has the capacity to uptake and/or release a fluid. Non-limiting specific examples of absorbent articles include absorbent articles worn next to the human body, in particular sanitary napkins, panti-liners, interlabial pads, tampons, diapers, pull-on diapers, training pants, incontinence products, wound dressings, and the like. Other non-limiting specific examples of absorbent articles include paper towels, facial tissue, diaper wipes, floor wipes, countertop wipes, body wipes, toddler wash wipes, bath tissues, toilet paper, handkerchiefs, feminine wipes, breast pads, household wipes, foam, and chamois.

As used herein “fluid” refers to a substance that may be absorbed into an absorbent article. Non-limiting specific examples of a fluid include water, artificial menstrual fluid, menstrual fluid, vaginal discharge, synthetic vaginal discharge, urine, synthetic urine, bowel movement fluids, bowel movement analogs, sweat, synthetic sweat, hexadecane, silicone oil, aqueous carbopol, and mineral oil. Additional non-limiting specific examples of a fluid also include a substance used for skin care, a lubricant, a surfactant, a cleanser, a detergent or other substance for which an absorbent article can be used to release or dispense a substance. Non-limiting specific examples of a fluid also include substances commonly spilled such as beverages, petroleum-based products, solvents, and vomit.

As used herein “saturation” refers to the fraction of the void space in an absorbent filled by the fluid. Saturation can be reported as a percentage or in decimal form.

As used herein “catamenial device” refers to a device used to manage menstruation. Catamenial devices include, but are not limited to, devices such as tampons, sanitary napkins, interlabial pads, and panti-liners.

As used herein, “heterogeneous” refers to a material comprised of more than one constituent or ingredient.

The present disclosure includes methods of simulating the physical behavior of fluid with a porous media. Embodiments of the present disclosure can at least assist in predicting whether or not a particular absorbent article design can adequately contain and distribute bodily fluids. As a result, particular absorbent article designs and absorbent materials can be evaluated and modified as computer based models before they are tested as real world things.

Computer aided engineering (CAE) is a broad area of applied science in which technologists use software to develop computer based models that represent real world things. The models can be transformed to provide various information about the physical behavior of those real world things, under certain conditions and/or over particular periods of time. With CAE, the interactions of the computer based models are referred to as simulations. Sometimes the real world things are referred to as a problem and the computer based model is referred to as a solution. There are several major categories of CAE.

Computation fluid dynamics (CFD) is another major CAE category. In CFD, models representing fluids (e.g. liquids and/or gases) are transformed to predict pressure, flow rate, velocity, temperature, and other fluid and/or thermal properties. CFD also represents a continuous fluid material as a set of discrete elements. A CFD element is often referred to as a cell, a finite difference cell, or a finite volume. However, for ease of reference, the term element is used throughout the present disclosure for CFD models. Unless otherwise stated, a reference to an element, in context of CFD, can refer to a cell, a finite difference cell, or a finite volume, as will be understood by one of ordinary skill in the art. In CFD, the fluid behavior is calculated for the elements, using equations that describe fluid behavior. For example, CFD often employs the Navier-Stokes equations, or variations thereof. The equations are solved iteratively, to represent the fluid behavior of the material as a whole.

Commercially available software can be used to conduct CAE. Fluent, from ANSYS, Inc. in Canonsburg, Pa., Flow3D, from Flow Science, Inc. in Santa Fe, N. Mex., and FeFlow from DHI-WASY in Berlin, Germany are examples of commercially available CFD software.

Alternatively, CAE software can be written as custom software or may be open source code software, for example, OpenFOAM. CAE software can be run on various computer hardware, such as a personal computer, a minicomputer, a cluster of computers, a mainframe, a supercomputer, or any other kind of machine on which program instructions can execute to perform CAE functions.

CAE software can represent a number of real world things, such as absorbent articles. An absorbent article can receive, contain, and absorb bodily exudates (e.g. urine, menses, feces, etc.). Absorbent articles include products for sanitary protection, for hygienic use, and the like. Fluids modeled may be Newtonian or non-Newtonian.

Representative absorbents may be wearable, non-wearable, reusable, and/or disposable. Representative absorbents can be an absorbent article. An absorbent article can be a catamenial device comprising a topsheet, a backsheet, and an absorbent core disposed between the topsheet and backsheet. The absorbent article can be a diaper. The absorbent article can dispense a substance. The absorbent article can be selected from the group consisting of pull-on diapers, training pants, incontinence products, feminine wipes, diaper wipes, floor wipes, countertop wipes, body wipes, toddler wash wipes, bath tissues, breast pads, paper towels, toilet paper, facial tissue, wound dressings, handkerchiefs, household wipes, foam, and chamois. Some absorbent articles are wearable. A wearable absorbent article is configured to be worn on or around a lower torso of a body of a wearer. Examples of wearable absorbent articles include diapers and incontinence undergarments.

Some absorbent articles are disposable. A disposable absorbent article is configured to be disposed of after a single use (e.g., not intended to be reused, restored, or laundered). Examples of disposable absorbent articles include disposable diapers, disposable incontinence undergarments, as well as feminine care pads and liners.

Some absorbent articles are reusable. A reusable absorbent article is configured to be partly or wholly used more than once. A reusable absorbent article is configured such that part or all of the absorbent article is durable, or wear-resistant to laundering, or fully launderable. An example of a reusable absorbent article is a diaper with a washable outer cover.

The absorbent can be selected from the group consisting of nonwovens, wovens, apertured polymer films, cellulosic materials, thermoplastic materials, air laid materials, sponges, absorbent gelling materials, foams, rayon, cotton, airfelt, creped cellulose wadding, meltblown polymers, and peat moss.

CAE can be used to design, simulate, and/or evaluate all kinds of absorbent articles, their features, materials, structures, and compositions, as well as their performance characteristics, such as swelling and deformation.

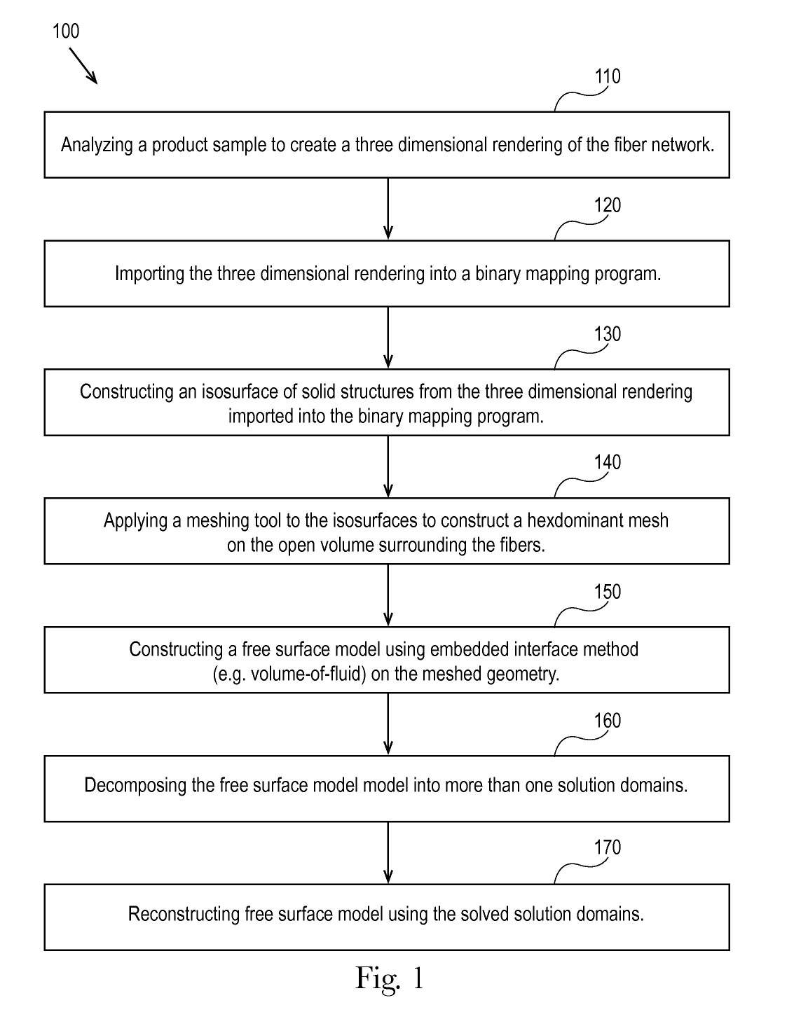

FIG. 1 is a chart illustrating a method 100 of steps 110-170 for using computer based models for simulating the physical behavior of bodily fluids with a porous material. Although the steps 110-170 are described in numerical order in the present disclosure, in various embodiments some or all of these steps can be performed in other orders, and/or at overlapping times, and/or at the same time, as will be understood by one of ordinary skill in the art.

The method 100 includes a first step 110 of analyzing a product sample to create a three dimensional rendering of the fiber network. The three dimensional rendering of the fiber network can be created by X-ray micro computer tomography or Digital Volumetric Imaging (DVI). The three dimensional rendering may be a high resolution image. A high resolution image is described as image whereupon the smallest detail observable is no less than 1% of the average fiber diameter, between about 5% and 10% of the average fiber diameter. The three dimensional rendering may be a grayscale image.

X-ray micro computer tomography can generate a grayscale image. X-ray micro tomography is a novel technique used in three-dimensional imaging of materials. This method consists of obtaining a large set of images while passing radiation through the sample at various angles. The projected images can be combined so as to reconstruct the geometry of the interior structure.

Digital Volumetric Imaging (DVI) permits routine generation of high-fidelity three-dimensional images of tissue and other materials. DVI captures high-resolution virtual sections directly from the blocks surface. This process, also called surface imaging microscopy, permits the collection of a much greater amount of information from each sample by automating the collection of large numbers of serial sections.

The micro-geometry of fibrous/porous material can also be obtained from output of other simulation tools that create 3D virtual fiber geometry based on desired performance of the material for specific product and manufacturing specifications. For example, virtual paper making model can generate 3D geometry of paper with distributed fiber diameters, length, porosity, surface properties, orientation and specific lay-down process. The resulting 3D geometry can be directly meshed in a similar way to meshing product geometry based on the micro CT scan grid.

The method 100 includes a second step 120 of importing the three dimensional rendering into a binary mapping program.

The method includes a third step 130 of constructing an isosurface of solid structures from the three dimensional rendering imported into the binary mapping program. An isosurface is a three-dimensional analog of an isoline representing points of a constant grayscale value within a volume of space; in other words, it is a level set of a continuous function whose domain is 3D-space. It is understood that one of ordinary skill in the art would appreciate the constant grayscale value. The isosurface may be constructed using a surface smoothing algorithm technique.

The method includes a fourth step 140 of applying a meshing tool to the isosurfaces to construct a hexdominant mesh on the open volume surrounding the fibers. At least one or more of the mesh boundaries are determined utilizing the constructed geometry isosurface. A mesh is a collection of small, connected polygon shapes that define the set of discrete elements in a CAE computer based model. The type of mesh and/or the size of elements can be controlled with user inputs into the meshing software, as will be understood by one of ordinary skill in the art.

The method includes a fifth step 150 of constructing a free surface model using embedded interface method (e.g. volume-of-fluid) on the meshed geometry. The free surface model may apply different contact angles to different fibers and boundaries based on the inputs to the model. The imbedded interface model may be solved numerically to show the time evolution of the free surface model.

The computer based model of the bodily fluid may be positioned and/or constrained in locations and concentrations that are similar to or the same as locations and amounts that represent a real world application of fluid/absorbent interaction. The location and spatial volume of the fluid may be represented by a field value in each cell. For example, the field value may define a starting location, a droplet size or volume of fluid, a droplet location, and/or a droplet shape or geometry. A field value may define multiple locations at various levels of fluid in the different locations. These locations and amounts can be determined by measuring actual samples, by using known values, or by estimating values. For example, real world locations and amounts of a bodily fluid can be determined by measuring (e.g. by X-ray. magnetic resonance imaging, or by another process) one or more actual samples of partially saturated and/or saturated absorbent articles.

The method includes a sixth step 160 of decomposing the free surface model model into more than one solution domains. The solution domains can be solved in a single CPU or more than one CPU in a parallel fashion. The model may be run in parallel using simultaneous executions on between 2 to 1000 processors; 50 to 800 processors; 100 to 500 processors.

The method includes a seventh step 170 of reconstructing free surface model using the solved solution domains. Once the model is transformed based on the solution domains, one can use known processing methods to attain information about the solved free surface model. The solved free surface model may be used to obtain, for suction pressure as a function of fluid loading, unsaturated fluid permeability, acquisition time of a fluid sample, fluid distribution in a multilayer fiber network, draining effectiveness of fluid in a gap, etc.

A visualization tool may be used to view and extract pertinent solution information from the monolithic data set. Pertinent solution information may include saturation of the porous media, pressure, fluid velocity, and/or fluid distribution through the porous media.

The movement of the fluid in the fiber network is determined using specialized, scientific, computer software. This computer software can be purchased from commercial vendors, obtained from government laboratories or extracted from open source repositories. This software allows for defining conditions on the external boundaries of the problem and on the surfaces of the fiber network. Examples of these conditions might be the pressure of the fluid, the velocity of the fluid, the presence or absence or fluid, and the contact angle of the fluid-gas interface on a solid surface. This software allows for defining the properties of the fluid. Examples of these properties would be the viscosity of the fluid, the density of the fluid, the surface tension at the fluid-gas interface. This software uses well-established numerical methods to find approximate solutions to the governing mathematical equations. These approximate solutions to the mathematical equations are often referred to as “solutions.” These solutions can change in time so that the fluid locations at one point in time will change to a different set of locations at a later point in time.

Examples of computer software that can solve the equations are FLOW3D, Fluent and OpenFOAM. Application of these software programs can differ in efficiency, robustness and accuracy. These differences often determine the choice of which software package to use.

The method may be run on multiple sets of materials at once using one or more processors. The method may be used to design a multilayer model based on the multiple sets of materials.

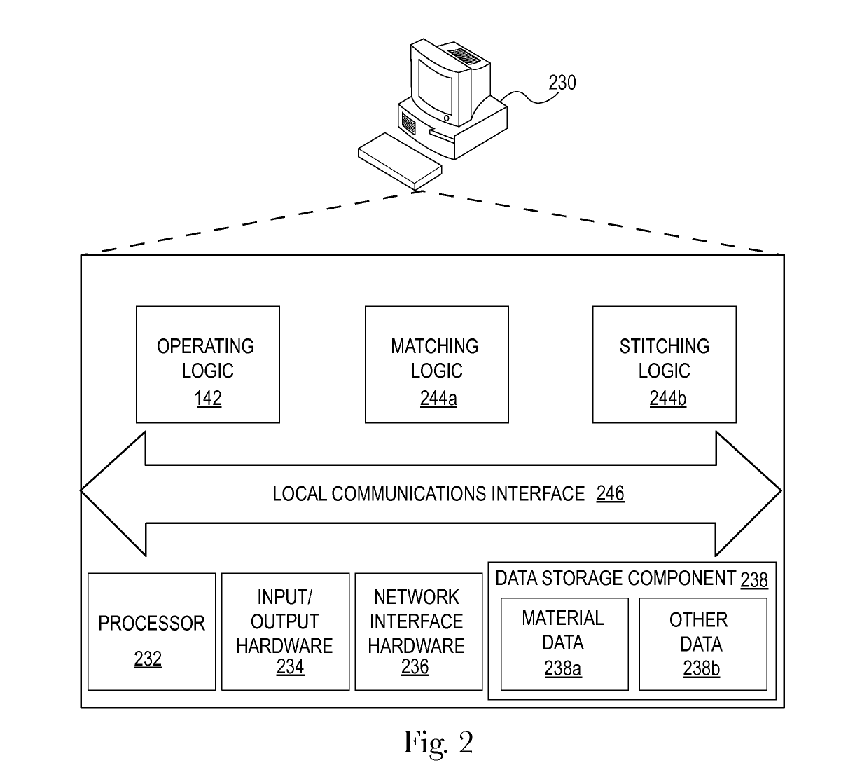

FIG. 2 depicts a computing device 230 for creating and utilizing a virtual environment, according to systems and methods disclosed herein. In the illustrated environment, the computing device 230 includes a processor 232, input/output hardware 234, network interface hardware 236, a data storage component 238 (which stores image data 238a and other data 238b), and a memory component 240. The computing devices 230,260 may comprise a desktop computer, a laptop computer, a tablet computer, a mobile phone, or the like.

The memory component 240 of the computing device 230 may be configured as volatile and/or nonvolatile memory and, as such, may include random access memory (including SRAM, DRAM, and/or other types of RAM), flash memory, registers, compact discs (CD), digital versatile discs (DVD), and/or other types of non-transitory computer-readable mediums. Depending on the particular configuration, these non-transitory computer-readable mediums may reside within the computing device 230 and/or external to the computing device 230.

Additionally, the memory component 240 may be configured to store operating logic 242, matching logic 244a, and stitching logic 244b, each of which may be embodied as a computer program, firmware, and/or hardware, as an example. A local communications interface 246 is also included in FIG. 2 and may be implemented as a bus or other interface to facilitate communication among the components of the computing device 230.

The processor 232 may include any processing component operable to receive and execute instructions (such as from the data storage component 238 and/or memory component 240). The input/output hardware 234 may include and/or be configured to interface with a monitor, keyboard, mouse, printer, camera, microphone, speaker, and/or other device for receiving, sending, and/or presenting data. The network interface hardware 236 may include and/or be configured for communicating with any wired or wireless networking hardware, a satellite, an antenna, a modem, LAN port, wireless fidelity (Wi-Fi) card, WiMax card, mobile communications hardware, and/or other hardware for communicating with other networks and/or devices. From this connection, communication may be facilitated between the computing device 230 and other computing devices.

Similarly, it should be understood that the data storage component 238 may reside local to and/or remote from the computing device 230 and may be configured to store one or more pieces of data for access by the computing device 230 and/or other components. In some systems and methods, the data storage component 238 may be located remotely from the computing device 230 and thus accessible via a network. Or, the data storage component 238 may merely be a peripheral device external to the computing device 230.

Included in the memory component 240 are the operating logic 242, the matching logic 244a and the stitching logic 244b. The operating logic 242 may include an operating system, web hosting logic, and/or other software for managing components of the computing device 230. Similarly, the matching logic 244a may be configured to cause the computing device 230 to collect and register, or match, adjacent images. Additionally, the stitching logic 244b may reside in the memory component 240 and may be configured to cause the processor 232 to stitch together the images, based on the suggested matching, to create the spherical images as described in more detail below.

It should be understood that the computing device 230 components illustrated in FIG. 2 are merely exemplary and are not intended to limit the scope of this disclosure. While the components in FIG. 2 are illustrated as residing within the computing device 230, this is merely an example. In some systems and methods, one or more of the components may reside external to the computing device 230. It should also be understood that, while the computing device 230 in FIG. 2 is illustrated as a single system, this is also merely an example. In some systems and methods, the modeling functionality is implemented separately from the prediction functionality, which may be implemented with separate hardware, software, and/or firmware.

Boundary conditions are defined variables that represent physical factors acting within a computer based model. Examples of boundary conditions include forces, pressures, velocities, and other physical factors. Each boundary condition can be assigned a particular magnitude, direction, and location within the model. These values can be determined by observing, measuring, analyzing, and/or estimating real world physical factors. In various embodiments, computer based models can also include one or more boundary conditions that differ from real world physical factors, in order to account for inherent limitations in the models and/or to more accurately represent the overall physical behaviors of real world things, as will be understood by one of ordinary skill in the art. Boundary conditions can act on the model in various ways, to move, constrain, and/or deform one or more parts in the model.

The computer based model can be created as described below, with general references to a computer based model of an absorbent article. A computer based model that represents an absorbent article can be created by providing dimensions and material properties to modeling software and by generating a mesh for the article using meshing software.

As used herein, the term free bodily fluid refers to a bodily fluid that is not absorbed within an absorbent material, but is free to move in, on, or through the absorbent article or be absorbed by the absorbent material.

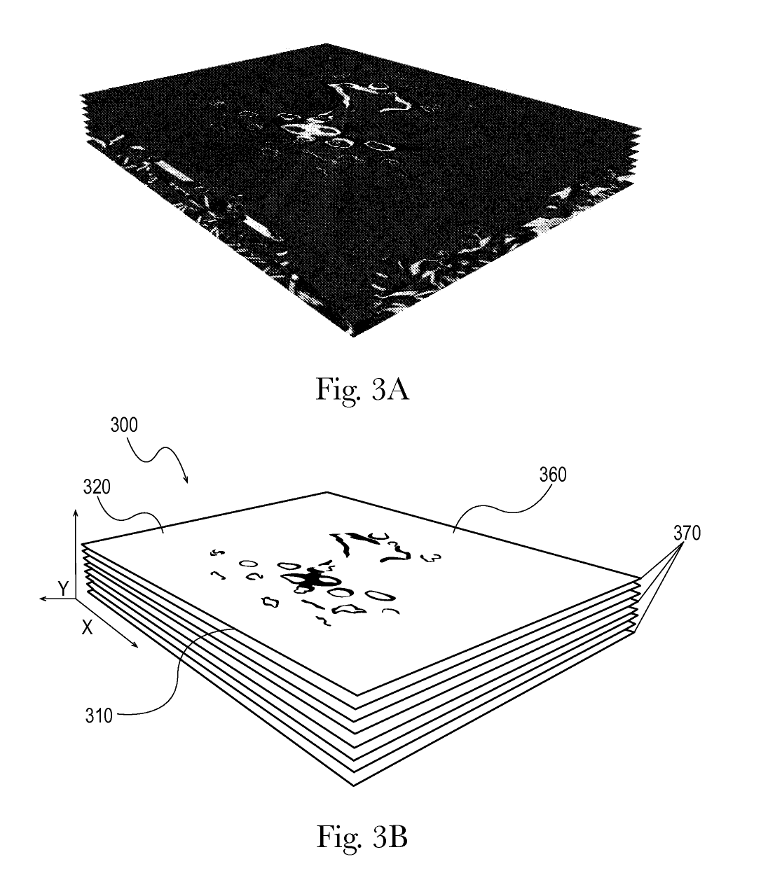

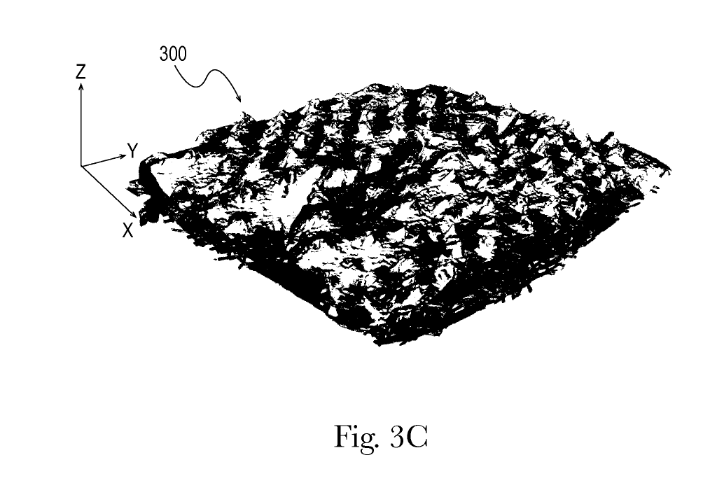

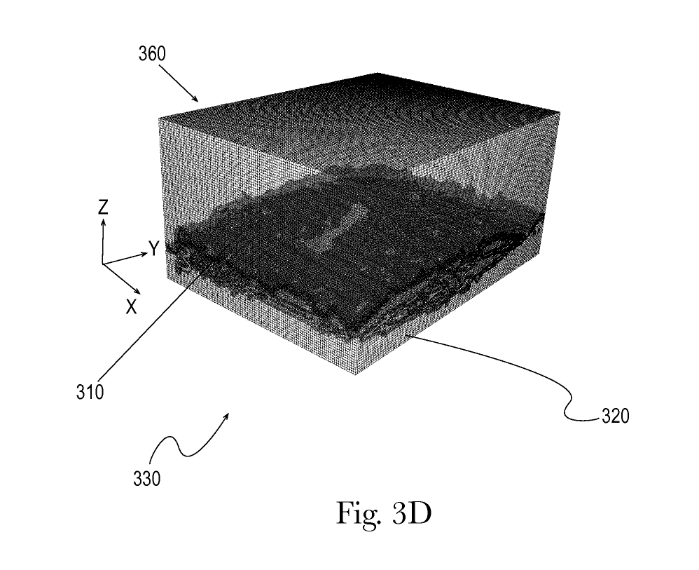

FIG. 3 is a high resolution image of the progression from micro CT tomography imagery to a 3D representation of a fibrous substrate sample broken up over FIGS. 3A-3D. The fibrous substrate sample contains fibers 310, air between fibers or void space. The smallest detail observable in the high resolution image is no less than 1% of the average fiber diameter, between about 5% and 10% of the average fiber diameter.

FIG. 3A contains a photo image of the micro CT scan grid. FIG. 3B contains a depiction of the micro CT scan grid 300. The micro CT scan grid is a set of two dimensional slice images through the geometry. The micro CT scan grid 300 comprises a micro CT scan axis, an x axis, and a y axis. The micro CT scan grid may contain from one slice 370 to one thousand slices. The slices 370 are parallel and perpendicular to the micro CT scan axis. The slices comprise both the void space 360 and the non-void space of a sample comprised of fibers 310 and solid film 320.

FIG. 3C contains a depiction of a surface rendering of the product geometry based on the micro CT scan grid. The surface rendering comprises a z axis, an x axis, and a y axis. The construction uses the data from the micro CT scan grid to compile a three dimensional rendering of the non-void fibrous substrate sample. The rendering depicts the fibers 310 and solid film 320.

FIG. 3D contains a depiction of a hexdominant mesh 330 constructed to fill the void space between the film and fibrous structures. The hexdominant mesh comprises a z axis, an x axis, and a y axis. The hexdominant mesh may comprise additional void space 360 along the z axis above or below the fibers 310 and film 320.

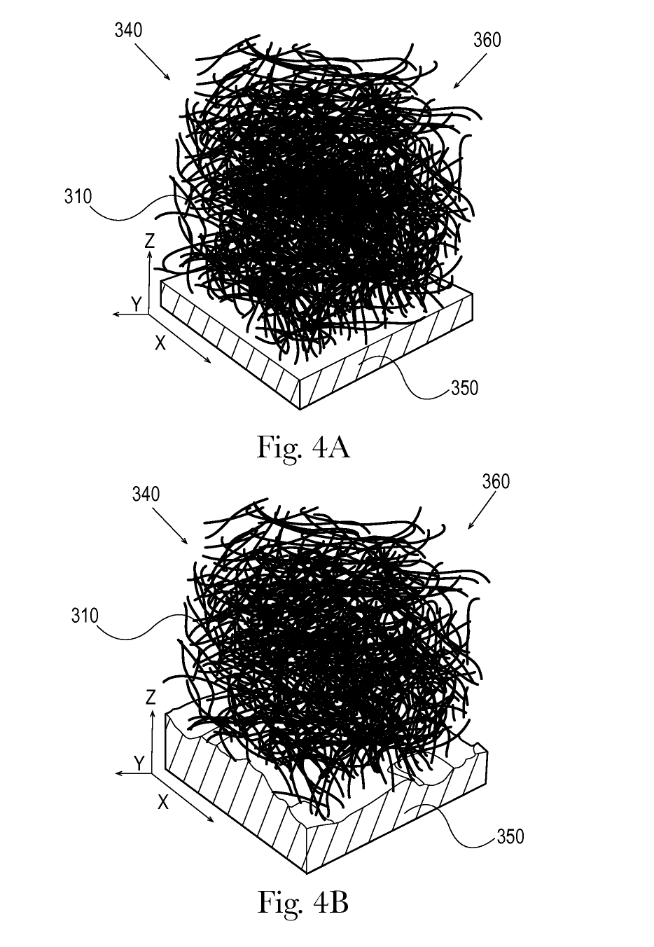

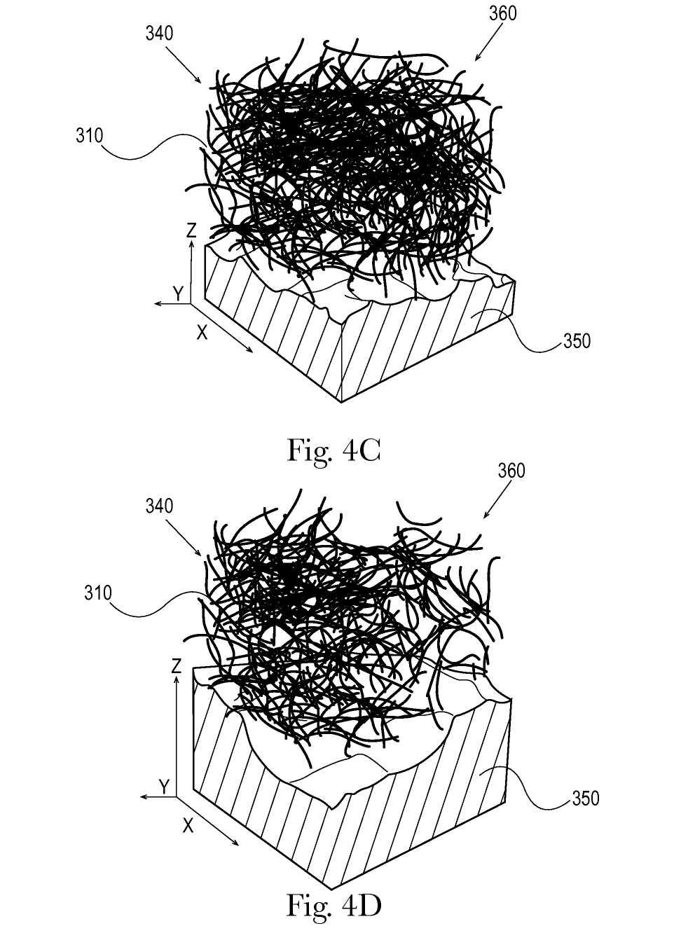

FIGS. 4A-D are a progression in time representation of fluid migration through a micro CT derived fiber geometry 340.

FIG. 4A contains fibers 310, air between fibers or void space 360, and fluid 350. The fibers 310, void space 360, and fluid 350 are limited by the boundaries set by the user. The void space 360 between the fibers 310 is clearly distinguished from the fibers 310. The fluid 350 may be inserted at any desired point in the fiber network. The fluid 350 may be of any volumetric dimension desired. The model insert may have additional fluid that has not yet entered the visual representation.

FIG. 4B is a representation of 4a after a fixed amount of time FIG. 4B contains fibers 310, air between fibers or void space 360, and fluid 350. The fibers 310, void space 360, and fluid 350 are limited by the boundaries set by the user. The void space 360 between the fibers 310 is clearly distinguished from the fibers 310. As shown in the figure, the model may determine where the fluid distributes as it is absorbed by the model. Additional fluid is absorbed by the model over time taken from the initial set amount of volume defined by the user.

FIG. 4C is a representation of 4A after a fixed amount of time. FIG. 4C contains fibers 310, air between fibers or void space 360, and fluid 350. The fibers 310, void space 360, and fluid 350 are limited by the boundaries set by the user. The void space 360 between the fibers 310 is clearly distinguished from the fibers 310. As shown in the figure, the model may determine where the fluid distributes as it is absorbed by the model. Additional fluid is absorbed by the model over time taken from the initial set amount of volume defined by the user.

FIG. 4D is a representation of 4A after a fixed amount of time. FIG. 4D contains fibers 310, air between fibers or void space 360, and fluid 350. The fibers 310, void space 360, and fluid 350 are limited by the boundaries set by the user. The void space 360 between the fibers 310 is clearly distinguished from the fibers 310. As shown in the figure, the model may determine where the fluid distributes as it is absorbed by the model. Additional fluid is absorbed by the model over time taken from the initial set amount of volume defined by the user. The model may continue to absorb fluid until it has found a saturation point or all of the designated fluid has been absorbed.

This method employs the volume-of-fluid method for specifying and tracking two fluids in a fiber network geometry. This section describes the basic mathematics underlying this method.

In an idealized fashion, a region occupied by two, immiscible, fluid phases can be characterized by the volume-of-fluid variable, γ(x,y,z,t). This scalar field is defined as the fraction of the volume in the neighborhood of a point that is occupied by one of the fluid phases. In the context of liquid-air models, this is usually the liquid phase. As a result, this variable will range only between zero and one. Theoretically, this field has a sharp discontinuity at the boundary between the two fluid phases. In practice, however, it transitions between zero and one over a short, non-zero distance related to the governing mesh size.

The volume-of-fluid variable is used to conflate the material properties of the separate phases into a single equation. For example, the density and viscosity functions can be expressed as follows:

ρ(γ)=ρ₁γ+ρ₂(1−γ)

and

η(γ)=η₁γ+η₂(1−γ)

where ρ₁ and ρ₂ are the densities of phase 1 and phase 2 respectively. Similarly, η₁ and η₂ are the individual phase viscosities.

Since the two phases are immiscible, evolution of the volume-of-fluid variable occurs according to the purely hyperbolic advection operator:

$$\frac{\partial γ}{\partial t} + ∇ \cdot ( {v}^{->} γ ) = 0$$

where \vec{ν} is a global fluid velocity field.

Under the assumption that both phases are incompressible, this velocity field can be obtained from the Navier-Stokes equations:

$$ρ ( γ ) \frac{\partial {v}^{->}}{\partial t} + ρ ( γ ) {v}^{->} \cdot ∇ {v}^{->} = - ∇ p + ∇ \cdot ( μ ( γ ) ∇ {v}^{->} ) + ρ ( γ ) {g}^{->} + {{ϕ}^{->}}_{Γ}$$

and continuity equations

∇·\vec{ν}=0

where p is the isotropic pressure and \vec{g} is the gravitational acceleration vector. The term, \vec{φ}_{Γ}, is a body force associated with the surface tension forces at the interface surface Γ. It can be found from the following equation:

\vec{φ}_{Γ}(\vec{r}_{Γ})=σ(∇·\vec{n}_{Γ})\vec{n}_{Γ}δ(\vec{r}_{Γ})

where σ is the surface tension, \vec{n}_{Γ}is the normal vector field to the interface surface, and δ(\vec{r}_{Γ}) is a Dirac function centered on the interface surface. The volume-of-fluid field is used to find both the interface surface location and its normal vector field.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of simulation, comprising:
a. analyzing a product sample to generate a three dimensional grayscale image;
b. importing the grey scale image into a binary mapping program;
c. constructing an isosurface of solid structures from the binary mapping;
d. applying a meshing tool to the exported isosurface to construct hexdominant mesh on open space surrounding the product geometry;
e. constructing a free surface model using an embedded interface method on the meshed geometry;
f. reconstructing the monolithic data set; and
g. employing a visualization tool to view and extract pertinent solution information from the monolithic data set.

2. The method of claim 1, wherein the step of constructing an isosurface further comprises treatment with a surface smoothing algorithm technique.

3. The method of claim 1, wherein the pertinent solution information comprises saturation, pressure, fluid velocity, and/or fluid distribution.

4. The method of claim 1, wherein the step of analyzing a product sample to generate a three dimensional grayscale image further comprises the use of x-ray micro computer tomography, a Digital Video Interface and/or stereolithographic (STL) formatting.

5. The method of claim 1, wherein the embedded interface model applies different contact angles to different fibers and boundaries.

6. The method of claim 1, wherein the embedded interface model is solved numerically to show the time evolution of the free surface model.

7. The method of claim 1, wherein executing the model in parallel comprises simultaneous execution on as many as 500 processors.

8. The method of claim 1, wherein the fields values defining a starting location further comprise a droplet size, droplet location, droplet shape, amount of fluid, the use of multiple locations, and/or combinations thereof.

9. The method of claim 1, wherein the method further comprises utilizing the method on a multiple set of materials.

10. The method of claim 6, wherein the method further comprises designing a multilayer model based on the multiple set of materials.

11. The method of claim 1, wherein the method further comprises the steps of defining field values to specify a starting location of a fluid phase.

12. The method of claim 1, wherein the method further comprises the steps of decomposing the mesh model into parallelized solution domains, and executing the model in parallel on decomposed geometry.

13. A method comprising:
a. analyzing a product sample to generate a three dimensional grayscale image;
b. importing the grey scale image into a binary mapping program;
c. converting the grey scale image to binary mapping;
d. constructing an isosurface of solid structures from the binary mapping;
e. exporting the isosurface as a stereolithographic file;
f. applying a meshing tool to the stereolithographic file to construct hexdominant mesh on open space surrounding the product geometry;
g. constructing a free surface model using an embedded interface method on the meshed geometry;
h. defining field values to specify a starting location of a fluid phase;
i. decomposing the mesh model into parallelized solution domains;
j. executing the model in parallel on decomposed geometry;
k. reconstructing the monolithic data set;
l. employing a visualization tool to view and extract pertinent solution information from the monolithic data set;
m. repeating the method on multiple sets of materials;
n. constructing a multilayer model; and
o. employing a visualization tool to view and extract pertinent solution information from the multilayer model.

14. The method of claim 13, wherein the step of constructing an isosurface further comprises treatment with a surface smoothing algorithm technique.

15. The method of claim 13, wherein the pertinent solution information comprises saturation, liquid fraction, pressure, fluid velocity and/or fluid distribution.

16. The method of claim 13, wherein the step of analyzing a product sample to generate a three dimensional grayscale image further comprises the use of x-ray micro computer tomography, a Digital Video Interface and/or stereolithographic (STL) formatting.

17. The method of claim 13, wherein the embedded interface model applies different contact angles to different fibers and boundaries.

18. The method of claim 13, wherein the embedded interface model is solved numerically to show the time evolution of the free surface model.

19. The method of claim 13, wherein executing the model in parallel comprises simultaneous execution on between 2 to 1000 processors.

20. The method of claim 13, wherein the fields values defining a starting location further comprise a droplet size, droplet location, droplet shape, amount of fluid, the use of multiple locations, and/or combinations thereof.
